(19) United States
(12) Patent Application Publication
(10) Pub. No.: US 2022/0162510 A1
(43) Pub. Date: May 26, 2022

(54) Method and apparatus for ionizing hydrocarbon fuels by electrolysis

(71) Applicants: Vasilii Fesenko, Bataisk (RU); Eric Woodell, Sinking Spring, PA (US)

(72) Inventors: Vasilii Fesenko, Bataisk (RU); Eric Woodell, Sinking Spring, PA (US)

(21) Appl. No.: 17/100,895

(22) Filed: Nov. 22, 2020

(51) Int. Cl. C10L 1/00

(52) U.S. Cl. CPC C10L 1/00; C10L 2230/22; C10L 2290/38

(57) ABSTRACT

A method for treating hydrocarbon fuel to improve the combustion characteristics of the fuel. The method comprises creating an electrolytic reaction, by applying high voltage AC through electrodes directly to the fuel. The fuel flows through the electrodes, and the applied voltage ionizes the fuel molecules, enhancing fuel distribution and improving combustion of the fuel. This results in reduced exhaust emissions, while improving both fuel economy and power. This can be used an any application where liquid or vapor hydrocarbon-based fuel is used.

### BACKGROUND OF THE INVENTION

### Field of the Invention

This invention relates to a method and apparatus for treating fuel to improve the combustion characteristics of the fuel. More particularly, the invention relates to a method and apparatus for treating fluid hydrocarbon fuel by applying high AC voltage and high frequencies to electrodes that are in contact with the fuel.

### Description of Related Art

Engines and systems that burn hydrocarbon fuels are well known to be inefficient, especially where the fuel is delivered in either a liquid or vapor form. The fuel is introduced into the airstream, creating a fuel-air mixture, but the fuel is unevenly dispersed within the air. Some fuel remains as small droplets that burn unevenly. Logically, the smaller and more dispersed the fuel droplets are, the more complete the fuel is burned. One of the ways to accomplish this is fuel ionization, where electrons are stripped off the fuel molecules, making the molecules positively charged. The results are that the like-charged molecules repelling each other and more readily combine with oxygen molecules as they are mixed with air in the combustion area, resulting in smaller droplets, or even a fuel vapor. The result is a more even burn of the air-fuel mixture, increasing combustion temperature and a higher efficiency, leading to improved fuel economy and more power. An additional effect of fuel ionization technology is a reduction of emitted air pollutants, since less unburned fuel remains.

### Prior Art

U.S. Pat. No. 8,763,590 describes 12 VDC or 120 VAC applied to fuel to induce an electrolytic reaction with ethanol to separate the gasoline and alcohol into their constituent parts for better fuel combustion.

U.S. Pat. No. 3,973,543 describes the application of high voltage, high frequency AC power into the intake manifold of an engine, to promote vaporization of fuel-air mixture.

U.S. Pat. No. 9,316,184 describes the application of high voltage DC power into a fuel line, to reduce the size of fuel droplets, thereby increasing power output through more efficient combustion of the fuel.

### Limitations of Prior Art

The prior art U.S. Pat. No. 8,763,590 relies on a tortuous path to extend the exposure of the fuel to the DC or AC voltage, to increase the electrolysis of the fuel. The electrolytic reaction is localized within the “fuel generator” itself, and is limited in both voltage and frequency applied to the fuel—either 12 VDC or 120 VAC and 60 Hz. This prior art is comparatively large—2 to 6 inches in diameter, and up to 24 inches in length. The prior art has a electrical current draw of 12 to 18 amperes, or total power consumed of 144 to 216 watts. The prior art has no means to adjust voltage and/or frequency for the application of different fuels

The prior art U.S. Pat. No. 3,973,543 attempts to improve the vaporization of a fuel-air mixture by introducing high voltage into the intake manifold, where the fuel-air mixture is waiting to be injected into the engine. It does not do so in the fuel line itself. Another issue is that introducing high voltage potential into a premixed fuel-air mixture has the unfortunate tendency to ignite said fuel-air mixture, typically resulting in catastrophic failure of the engine.

The prior art U.S. Pat. No. 9,316,184 is similar in that it supplies power to the fuel in the fuel line. But it applies Direct Current (DC) power only, not Alternating Current (AC) as our invention does. Using DC power restricts the effectiveness of the unit due to limitations on the magnitude of voltage that can be practically applied. DC power applications to liquid systems of engines will also tend to promote galvanic corrosion in systems where power is applied, resulting in premature failure of engines. Finally, DC power applications lack the ability to provide real-time feedback to adjust voltages and frequencies to optimize results.

### SUMMARY OF THE INVENTION

The present invention relates to relates to a method and apparatus to create high voltage, up to 1000 VAC at relatively high frequencies of up 300,000 Hz and then apply this directly to the fuel stream itself, ionizing all fuel in the sealed fuel system through electrolysis. By applying high voltage to electrodes located inside the case of the device near the fuel inlet, and the return path the conductive outlet of the unit, a strong potential is applied directly to the fuel, creating an electrolytic reaction. while avoiding interference with vehicle electronics. The present invention controller integrates protective circuitry to avoid damage or interference with vehicle electronic systems and computers, by using a feedback circuit to maintain optimal frequency and voltage within the FTU, based on viscosity and conductivity of the fuel. The result is an ionizing of most or all fuel molecules, especially within the housing of the device. The fuel molecules, now all having a like electrical charge, repel each other as the fuel is mixed with air. This in turn creates a homogenous distribution of fuel-air mixture, almost down to the molecular level. When the fuel-air mixture is ignited, optimal combustion is achieved. The result is increased power for a given amount of fuel, or reduced fuel consumption for a given amount of work. The current invention is comparatively small in size, 7 inches or less in length, and less than 2 inches in diameter. The current invention is energy efficient, with an electrical current draw of less than two amperes (from a 12 VDC source) for a maximum power consumption of ˜25 watts. The current invention utilizes pulse-width modulation with real-time feedback circuitry to optimize ionization of the fuel molecules to enhance results.

This fuel treatment method can be utilized in any application where liquid hydrocarbon fuel is used, including but limited to internal combustion engines, electrical power production, residential heating, or aviation air-breathing reaction engines including turbojets and turbofans.

### BRIEF DESCRIPTION OF THE DRAWINGS

FIG. 1 is a block diagram of the fuel treatment device and controller;

FIG. 2 is a side elevation sectional view illustrating the fuel treatment device constructed in accordance with the principles of my invention;

FIG. 3 is a transverse sectional view illustrating the fuel treatment apparatus of FIG. 2 and taken along section line A-A thereof;

FIG. 4 is a representative schematic of the controller.

### DETAILED DESCRIPTION OF THE INVENTION

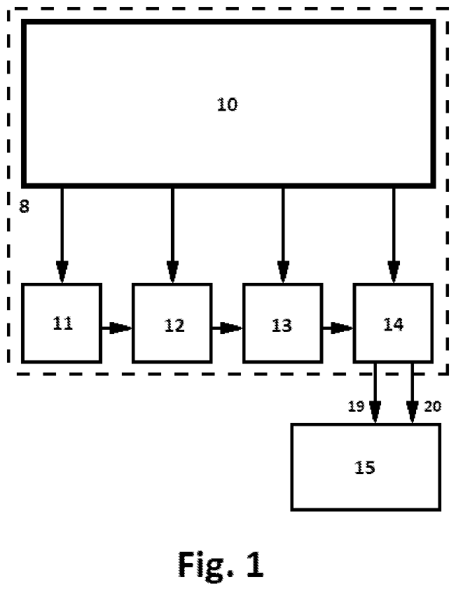

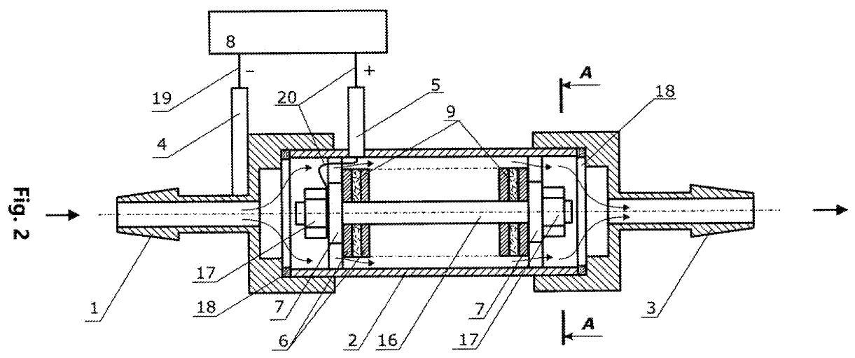

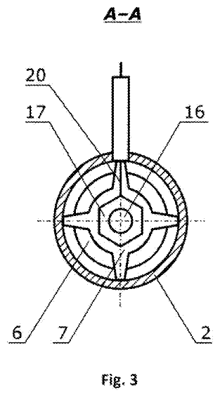

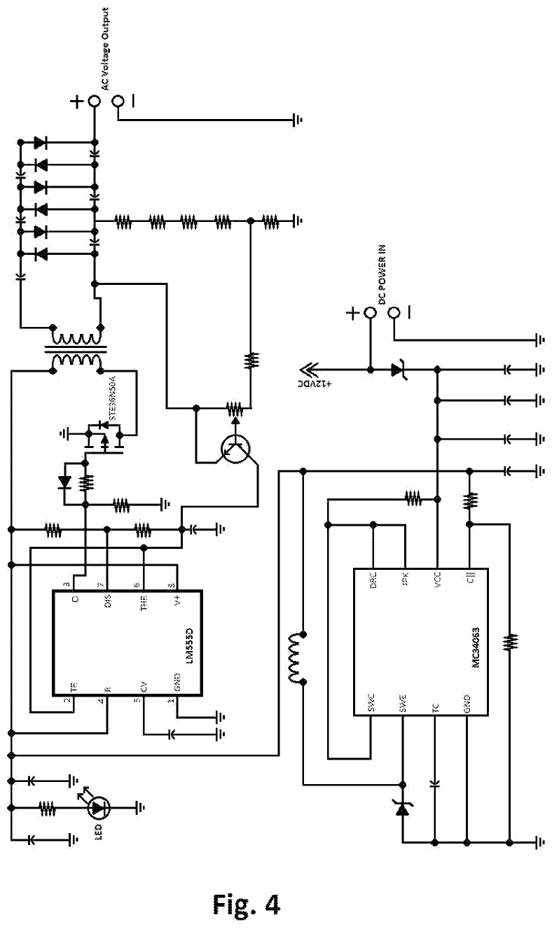

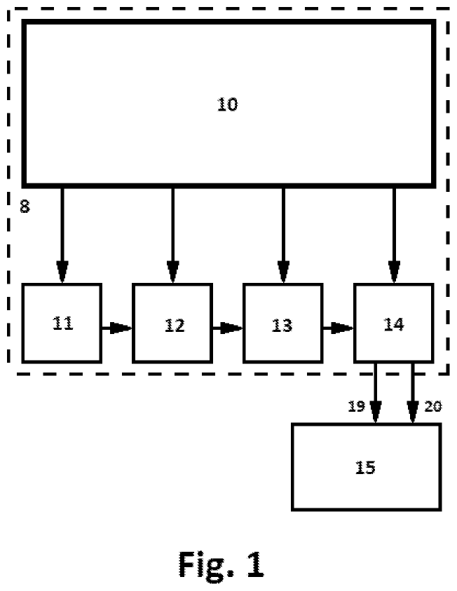

FIG. 1 block diagram: When power is supplied from the vehicle electrical system, Block 8 is turned on, the power supply filter 10 provides supply voltage to the master oscillator 11, the amplifier 12, electrical isolation transformer 13 and the voltage amplifier 14. At the same time, the master oscillator 11 generates 300 kHz square triggers amplifier 12 current and voltage. Next, the amplified signal is supplied to the galvanic isolation transformer 13 and to the diode-capacitor voltage amplifier 14. After passing through the diode-cascade circuit the now high voltage potential is applied to the fuel from the electrodes 6 and the housing 2, through connecting wires 19 and 20. Depending on the conductance and viscosity of the fuel between the electrodes and the housing, the voltage applied to the FTU will vary slightly, providing a feedback mechanism to alter the frequency and voltage applied. This enables the controller to automatically adjust applied voltage and frequency within a narrow band, to accommodate minor variations in fuels, such as octane variations in gasoline. The controller design values for voltage and frequency applied to the FTU will vary depending on the intended fuel.

FIG. 2 is a side elevation sectional view illustrating the fuel treatment device constructed in accordance with the principles of my invention;
1. Input fitting made of brass, stainless steel or aluminum
2. Housing of the fuel treatment unit (FTU) made of brass, stainless steel or aluminum
3. Outlet fitting made of brass, stainless steel or aluminum.
4. Contact for applied high-voltage
5. Contact for the connection of the electrodes 6 with the source of high-voltage (the controller)
6. Electrodes made of brass, stainless steel or aluminum.
7. Dielectric washer
8. Source of high voltage for electrolysis (the controller)
9. Dielectric inserts
16. Rod
17. Clamping nut
18. Gasket/seal
19. and 20. Connecting wires

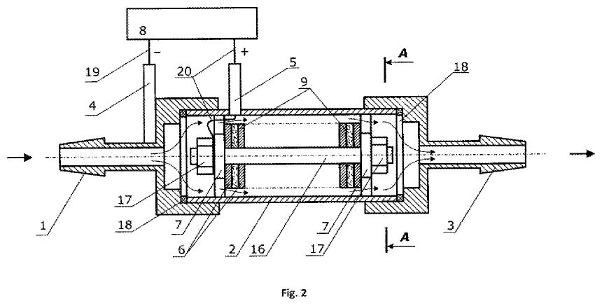

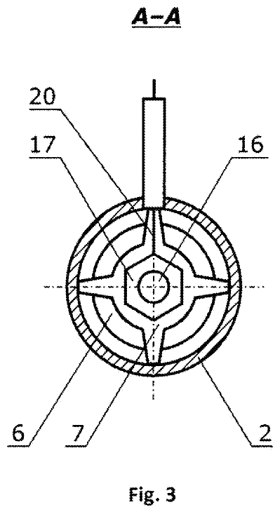

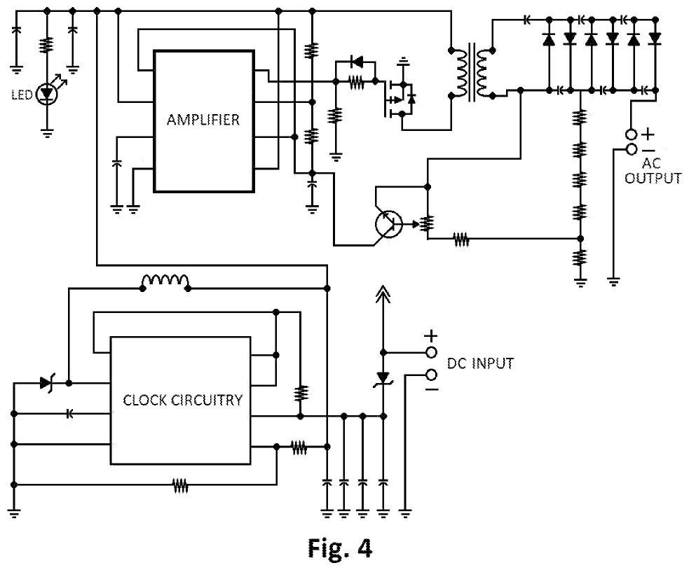

FIG. 3 is a transverse sectional view illustrating the fuel treatment apparatus of FIG. 2 and taken along section line A-A therof. The numbers of FIG. 3 are listed above.

Having described my invention in such terms as to enable those skilled in the art to understand and practice it, and having identified the presently preferred embodiments thereof, I claim:

1. A method for reducing the size of fuel droplets to be used for combustion comprising the steps of:
a. providing a flow of fuel through the fuel line;
b. subjecting the fuel to an alternating current electrical field of high voltage and high frequency sufficient to uniformly ionize the fuel resulting in the like-charged molecules repelling each other;
c. allowing the fuel to flow to the combustion chamber.

2. The method according to claim 1, wherein step b. comprises subjecting the fluid to the electrical field between 5 and 60 seconds.

3. An apparatus for reducing the size of fuel droplets injected into a combustion chamber comprising of: a fuel line; a metallic input fitting; a metallic housing; metallic electrodes inside the housing, insulated from the housing with dielectric inserts to prevent electrical conduction between the metallic housing or input fitting and the electrodes; and an electrical power supply electrically coupled to the input fitting and electrodes, wherein the electrical supply generates an electrical field between the electrodes and input housing, the electrical field having a strength of about 1000 Volts; and a fuel injector disposed at the end of the fuel line, downstream of the electrodes.

4. The apparatus to claim 3, wherein the electrical source comprises of alternating current.

5. A method of reducing fuel consumption comprising: flowing fuel through a fuel line; applying an alternating current electrical field to the fuel within the line to ionize the fuel, the electrical field having a strength of about 1000 VAC at a frequency of about 300 KHz; and discharging the fuel with ionized molecules through a fuel injector into a combustion chamber for combustion.

6. A method of increasing power output from a combustion engine comprising: flowing fuel through a fuel line; applying an alternating current electrical field to the fuel within the line to ionize the fuel, the electrical field having a strength of about 1000 VAC at a frequency of about 300 KHz; and discharging the fuel with ionized molecules through a fuel injector into a combustion chamber for combustion.

7. A method for reducing exhaust emissions from a combustion engine comprising: flowing fuel through a fuel line; applying an alternating current electrical field to the fuel within the line to ionize the fuel, the electrical field having a strength of about 1000 VAC at a frequency of about 300 KHz; and discharging the fuel with ionized molecules through a fuel injector into a combustion chamber for combustion.
